(19) United States
(12) Patent Application Publication
(10) Pub. No.: US 2002/0015071 A1
(43) Pub. Date: Feb. 7, 2002

(54) Inkjet recording apparatus

(76) Inventors: Kensei OOtsubo, Fukuoka (JP); Masaharu Tanaka, Fukuoka (JP); Tadashi Maki, Fukuoka (JP); Yutaka Miyazono, Fukuoka (JP); Shinichi Michiyama, Fukuoka (JP)

Correspondence Address: WENDEROTH, LIND & PONACK, L.L.P., 2033 K STREET N. W., SUITE 800, WASHINGTON, DC, 20006-1021, US

(21) Appl. No.: 09/885,101

(22) Filed: Jun. 21, 2001

(30) Foreign Application Priority Data
Jun. 22, 2000 (JP) 2000-187278
Jun. 22, 2000 (JP) 2000-187279
Jun. 22, 2000 (JP) 2000-187280

(51) Int. Cl. B41J 23/00

(52) U.S. Cl. 347/37

(57) ABSTRACT

An inkjet recording apparatus includes (a) a carriage, (b) a recording head mounted to the carriage, (c) a transferring machine for transferring a recording medium, (d) a driving machine for operating the transferring machine, (e) a driving-force-transmitting-machine disposed between both the machines, and for transmitting the driving force of the driving machine, (f) a rotary detector mounted to a rotating shaft of any one of rotating members constituting the driving-force-transmitting-machine, and disposed within the height of the driving-force-transmitting-machine, and (g) a detecting sensor for detecting a rotating angle of the rotary detector. In this structure, even if other members hit an element of the driving-force-transmitting-machine, they never hit the rotary detector. Thus the rotary detector is prevented from being damaged or deformed due to shocks.

### FIELD OF THE INVENTION

The present invention relates to an inkjet recording apparatus, which ejects ink from nozzles and attaches the ink to a recording medium, thereby recording information.

### BACKGROUND OF THE INVENTION

An inkjet recording apparatus is capable of printing a high-quality letter at a high speed and at a low cost. The apparatus is employed in a copy machine, facsimile, printer and word-processor, and thus widely used as an information recording apparatus in offices as well as for a personal use. Various techniques have been proposed to improve this inkjet recording apparatus, and nowadays they still focus on a higher speed recording, a higher resolution, and full-color printing.

The following recording methods are available in the inkjet recording: A method employing an electrothermal transducing element, such as a heating resistor, as energy-generating-means for expelling color material; a method employing an electromechanical transducing element such as a piezo element; an electrostatic method employing electrical energy as it is; and the like. Regarding a recording head employed in the apparatus, a serial scanning head is commercialized. This head is mounted to a carriage and movable in a direction (main scanning direction) orthogonal to a transfer direction of recording paper (sub-scanning direction.)

As one of means for high speed recording, a dc motor is employed in the apparatus as a transfer motor for driving a transfer roller which transfers recording paper. This dc motor is easy for adjusting a speed and gains relatively large torque. A rotary detector is provided for detecting a rotating angle of the transfer motor in order to correctly control the feeding amount of the recording paper. On the rotary detector, slits radially extending are formed on the entire rim of the rotary detector at equal intervals.

The rotary detector is disposed coaxially with any gear (rotating member) of transmission gear-row (driving force transmitting machine) which is placed between the transfer motor and the transfer roller. The transmission gear-row transmits the driving force of the transfer motor to the transfer roller.

The structure of the conventional inkjet recording apparatus discussed above has the following problems: The first one refers to damage of the rotary detector. The rotary detector is often formed of thin plastic members. Such a delicate detector is vulnerable to being damaged due to careless mistake by an operator at an assembling line of the apparatus, e.g., a shock by collision with other member. If the rotary detector is damaged, it is impossible to detect a rotating angle with a detecting sensor, or if the rotary detector is deformed, the rotating face of the detector shakes, and it is impossible to detect a correct rotating angle.

The second problem refers to stains on the rotary detector. The rotary detector can detect a rotating angle at greater accuracy with a larger diameter. However, the larger diameter for the greater accuracy prevents the apparatus from being downsized. When a high-quality letter is printed at a high speed, the recording head moves rapidly and the nozzle ejects smaller amount of ink, thus the ink tends to scatter. Then the ink scattering attaches to the rotary detector, thereby producing an error at detecting a rotating angle. A smaller diameter of the rotary detector would avoid this problem; however, the smaller detector would produce another problem, i.e., lowering the accuracy of detecting a rotating angle.

The third problem refers to eccentricity of the rotary detector. The rotary detector must be mounted to a rotating shaft without eccentricity both in radial and thrust directions. Therefore, it is preferable to check the eccentricity of the detector with ease.

The forth problem refers to a size of the rotary detector. For detecting a rotating angle of the transfer motor, it is required to optically detect, with a detecting sensor, a number of slits moved on the rotary detector rotated by the transfer motor. When the detecting sensor is a transmission type, its light-emitting-section and light-receiving-section are placed at both sides of the rotary detector, and the detecting sensor is mounted to the rim of the rotary detector. As a result, the detecting sensor protrudes largely in the radial direction comparing with the gear disposed coaxially with the rotary detector. This structure is not preferable because it is against the request of downsizing the apparatus.

### SUMMARY OF THE INVENTION

An objective of the present invention is to overcome the first problem discussed above, and aims to provide an inkjet recording apparatus which can avoid damages or deform at assembling the rotary detector to be mounted to a driving-force-transmitting-machine. The inkjet recording apparatus of the present invention comprises the following elements:

(a) a carriage disposed movable reciprocally in parallel with a main scanning direction;

(b) a recording head mounted to the carriage, and ejecting ink from a plurality of nozzles;

(c) a transferring machine for transferring a recording medium, to which the ink ejected from the recording head attaches thereby forming an image, in a sub-scanning direction orthogonal to the main scanning direction;

(d) a driving machine for operating the transferring machine;

(e) a driving force transmitting machine disposed between the driving machine and the transferring machine, and transmitting driving force of the driving machine to the transferring machine;

(f) a rotary detector disposed within a height of the driving force transmitting machine, and mounted coaxially with the rotating shaft of any one of rotating members constituting the driving force transmitting machine; and

(g) a detecting sensor for detecting a rotating angle of the rotary detector.

This structure allows the rotary detector to avoid colliding with other members at assembly of the apparatus even if the other members collide with elements of the driving force transmitting machine. Thus the rotary detector is prevented from being damaged or deformed by a collision.

The present invention overcomes the second and third problems discussed previously, and aims to provide an inkjet recording apparatus which can detect the rotating angle of the rotary detector at high accuracy, and yet, downsize the rotary detector. Besides, the apparatus can check eccentricity of the rotary detector mounted to the rotating shaft with ease.

The inkjet recording apparatus of the present invention comprises the following elements:

(a) a carriage disposed movable reciprocally in parallel with a main scanning direction;

(b) a recording head mounted to the carriage, and ejecting ink from a plurality of nozzles;

(c) a transferring machine for transferring a recording medium, to which the ink ejected from the recording head attaches thereby forming an image, in a sub-scanning direction orthogonal to the main scanning direction;

(d) a driving machine for operating the transferring machine;

(e) a driving force transmitting machine disposed between the driving machine and the transferring machine, and transmitting driving force of the driving machine to the transferring machine;

(f) a rotary detector mounted coaxially with a rotating shaft of any one of gears constituting the driving force transmitting machine, and slits extending in the radial direction of the detector-being provided on the entire rim of the detector at equal intervals, and at least a part of the slits being disposed within a height of tooth form of the gears; and

(g) a detecting sensor for detecting a rotating angle of the rotary detector through a number of slits moved due to the rotation of the rotary detector.

Since at least a part of the slits of the rotary detector are placed within the height of tooth form of the gears, this structure allows the rotary detector to be accurately detected and downsized. Further, rotating conditions of the rotary detector can be compared with that of the gears by rotating the shaft, so that the eccentricity of the rotary detector can be checked with ease.

The present invention overcomes the fourth problem discussed previously, and aims to provide an inkjet recording apparatus having a transmission type detecting sensor disposed with respect to the rotary detector mounted coaxially with a rotating member. In this transmission type detecting sensor, protrusion amount of the sensor toward outside in the radial direction of the rotating member can be restrained. The inkjet recording apparatus of the present invention comprises the following elements:

(a) a carriage disposed movable reciprocally in parallel with a main scanning direction;

(b) a recording head mounted to the carriage, and ejecting ink from a plurality of nozzles;

(c) a transferring machine for transferring a recording medium, to which the ink ejected from the recording head attaches thereby forming an image, in a sub-scanning direction orthogonal to the main scanning direction;

(d) a driving machine for operating the transferring machine;

(e) a driving force transmitting machine disposed between the driving machine and the transferring machine, and transmitting driving force of the driving machine to the transferring machine;

(f) a rotary detector mounted coaxially with a rotating shaft of any one of the rotating members constituting the driving force transmitting machine, and slits-extending in the radial direction of the detector-being provided on the entire rim of the detector at equal intervals; and

(g) a detecting sensor including:

(g-1) a light-emitting-section for irradiating a beam of detecting light to the slits on the rotating detector; and

(g-2) a light-receiving-section for receiving the beam of detecting light irradiated from the light-emitting-section, and disposed opposite to the light-emitting-section with respect to the rotary detector.

This sensor recognizes light-shading and light-transmission of the detecting light at the light-receiving-section, thereby detecting the rotating angle of the rotary detector. The light-shading and light-transmission of the detecting light is produced when the rotary detector rotates and the slits move. Either one of the light-emitting-section or the light-receiving-section is disposed between the rotating member and the rotary detector. This structure allows the rotary detector to have approx. the same diameter as the rotating member. Thus the detecting sensor disposed with respect to the rotary detector can restrain the protrusion amount of the rotating member toward outside in the radial direction.

### BRIEF DESCRIPTION OF THE DRAWINGS

FIG. 1 is a schematic perspective view of an inkjet recording apparatus in accordance with a first exemplary embodiment of the present invention.

FIG. 2 is a lateral view illustrating an essential part of the inkjet recording apparatus shown in FIG. 1.

FIG. 3 illustrates an example of a height of a transmission-gear-row shown in FIG. 2.

FIG. 4 illustrates another example of the height of the transmission-gear-row.

FIG. 5 illustrates still another example of the height of the transmission-gear-row.

FIG. 6 is a lateral view of an essential part of an inkjet recording apparatus in accordance with a second exemplary embodiment of the present invention.

FIG. 7 illustrates an example of a relation between the final gear of a transmission-gear-row and slits formed on a rotary detector in an inkjet recording apparatus in accordance with a third exemplary embodiment.

FIG. 8 illustrates another example of the relation between the final gear and the slits.

FIG. 9 illustrates still another example of the relation between the final gear and the slits.

FIG. 10 illustrates yet still another example of the relation between the final gear and the slits.

FIG. 11 illustrates further another example of the relation between the final gear and the slits.

FIG. 12 is a cross sectional view showing the final gear and the rotary detector.

FIG. 13 is a plan view showing an essential part of an inkjet recording apparatus in accordance with a fourth exemplary embodiment.

### DETAILED DESCRIPTION OF THE INVENTION

Exemplary embodiments of the present invention are demonstrated hereinafter with reference to the accompanying drawings.

### First Exemplary Embodiment

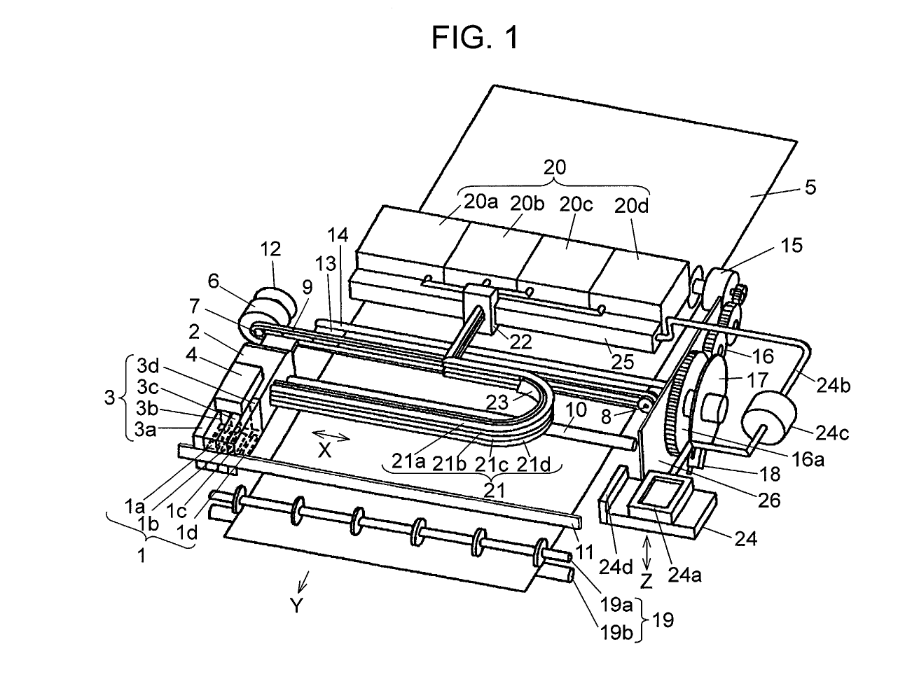

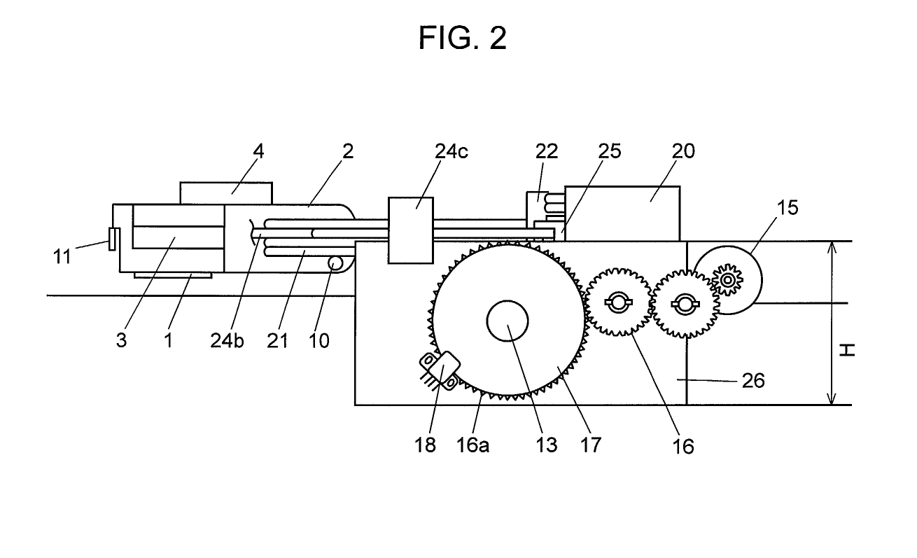

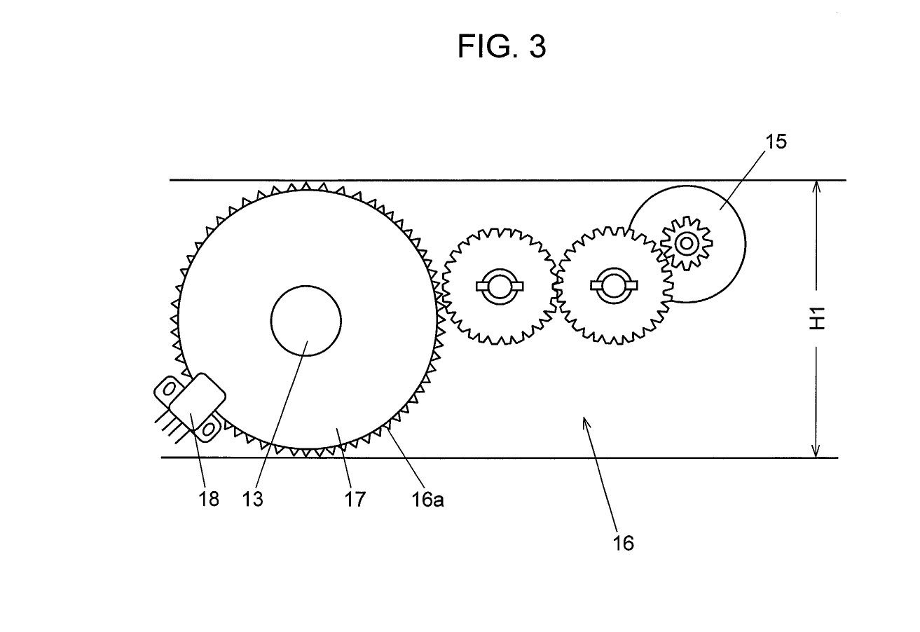

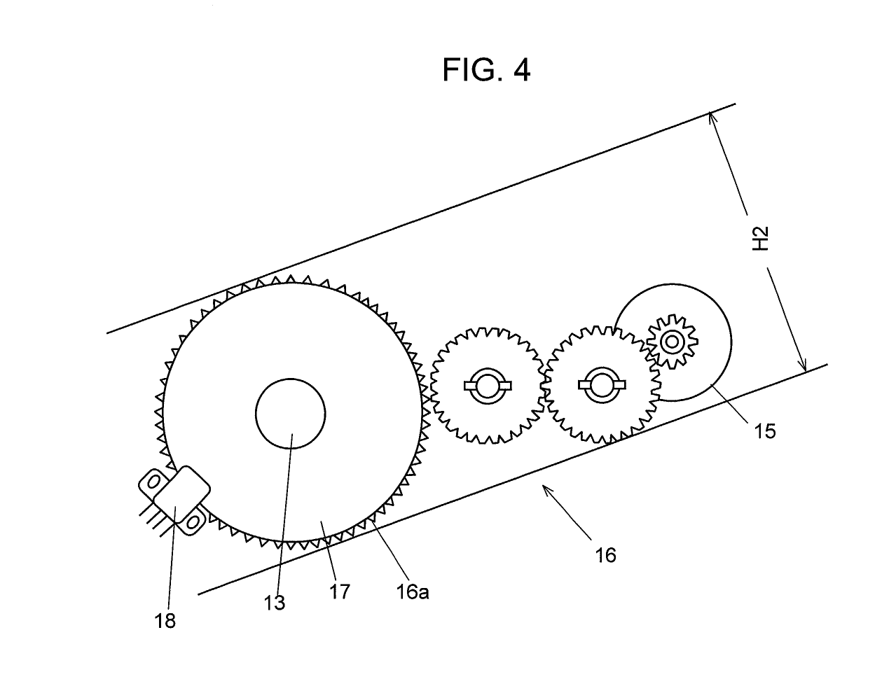

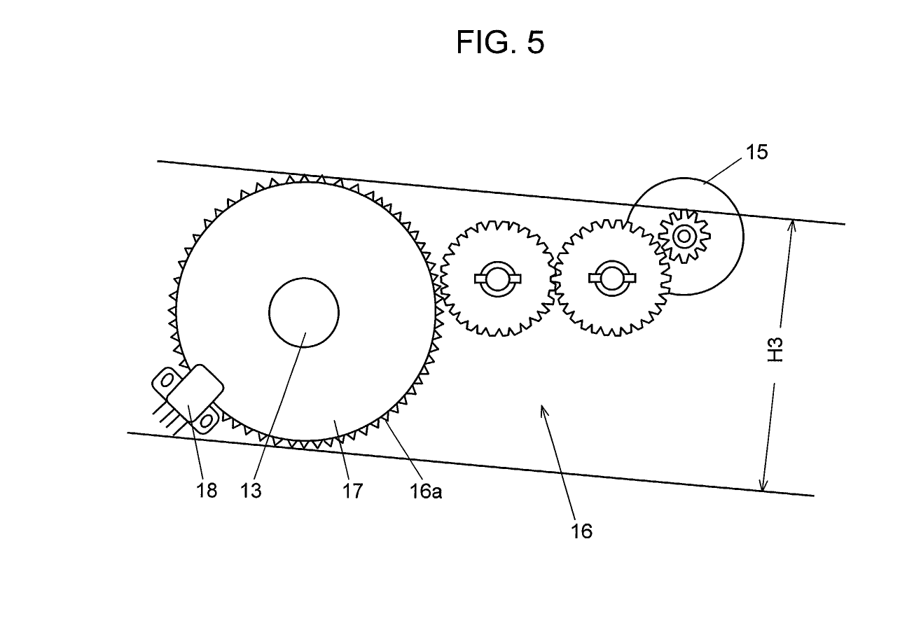

FIG. 1 is a schematic perspective view of an inkjet recording apparatus in accordance with the first exemplary embodiment of the present invention. FIG. 2 is a lateral view illustrating an essential part of the inkjet recording apparatus shown in FIG. 1. FIG. 3 illustrates an example of a height of a transmission-gear-row shown in FIG. 2. FIG. 4 illustrates another example of the height of the transmission-gear-row. FIG. 5 illustrates still another example of the height of the transmission-gear-row. In these drawings, the same elements bear the same reference marks, and descriptions duplicated are avoided.

In FIG. 1, the inkjet recording apparatus, in accordance with the first embodiment, includes recording head 1 which ejects a plurality of colored inks. Head 1 comprises black-recording-head 1a ejecting black ink, yellow-recording-head 1b ejecting yellow ink, magenta-recording-head 1c ejecting magenta ink, and cyan-recording-head 1d ejecting cyan ink. A plurality of nozzles (not shown) are formed in respective heads 1a, 1b, 1c and 1d. Sub-tanks 3a, 3b, 3c and 3d are disposed above respective heads 1a, 1b, 1c and 1d. Each sub-tank 3a, 3b, 3c and 3d reserves black ink, yellow ink, magenta ink and cyan ink respectively, and supplies the ink to the corresponding heads 1a, 1b, 1c and 1d. Head 1 and sub-tank 3 are disposed in parallel with carriage 2 in the moving direction of carriage 2.

Heads 1a, 1b, 1c and 1d can be independent or united (linked.) A number of colors is not limited to 4 described in this embodiment. If the number of colors is other than 4, the numbers of recording heads, ink-tanks, sub-tanks and supplying tubes are varied accordingly.

A pressure room to be filled with ink and a piezoelectric actuator (both are not shown) are disposed at a place corresponding to the nozzles of a head. The actuator includes a piezoelectric element and deforms the pressure room by applying a pulse voltage to the piezoelectric element so that the pressure room reduces its own capacity.

Driving circuit 4, disposed at carriage 2, operates the piezoelectric actuator, so that the ink in the pressure room is ejected downwardly from the nozzles to recording paper 5 (recording medium), which is transferred in Y direction (transfer direction) shown in FIG. 1. Instead of the piezoelectric actuator, a thermal actuator or an electrostatic actuator conventionally known can be used.

Recording head 1 is rigidly mounted to carriage 2, which is movable in X direction (main scanning direction) relatively to recording paper 5. X direction is orthogonal to Y direction, i.e., the main scanning direction crosses the sub-scanning direction, namely, transfer direction, at right angles.

Carriage 2 reciprocates above recording paper 5 with the following structure: Carriage driving motor 6 is disposed at a first side of X direction. Endless carriage driving belt 9 is looped on driving pulley 7 and follower pulley 8. Driving pulley 7 is mounted to the shaft of motor 6, and follower pulley 8 is disposed at opposite side to pulley 7, i.e., at a second side of X direction. Carriage 2 is rigidly placed in the span under belt 9. Motor 6 spins normally and inversely, so that belt 9 loops also in a normal or a reverse direction accordingly. Carriage shaft 10 extends in X direction and is mounted to the apparatus. Shaft 10 extends through carriage 2, which can slide with respect to shaft 10. Further, guide rail 11 is disposed on the other side of shaft 10 with respect to carriage 2, and runs parallel to shaft 10. Carriage 2 is guided by guide rail 11 such that carriage 2 can slide with respect to guide rail 11.

The structure discussed above allows belt 9 to loop with pulleys 7, 8 by spinning motor 6 in a normal or a reverse direction. Then carriage 2 fixed to belt 9 shuttles back and forth in X direction (scanning direction) above recording paper 5 with being supported by shaft 10 and guide rail 11.

Motor 6 is equipped with rotary detector 12, which detects the rotating amount of motor 6, i.e., a position of head 1 in X direction, with a detecting sensor (not shown.)

A transferring machine, i.e., transfer roller 13 is disposed under recording paper 5 extending in X direction. Pinch roller 14 is disposed above recording paper 5 extending in X direction. Pinch roller 14 urges recording paper 5 against transfer roller 13. In other words, recording paper 5 is pinched between transfer roller 13 and pinch roller 14.

A driving machine, i.e., transfer motor 15 is disposed at the second side of X direction and behind pinch roller 14 in Y direction. Transfer motor 15 is a dc motor. Between motor 15 (driving machine) and transfer roller 13 (transfer machine), a driving-force-transmitting machine for transmitting the driving force of motor 15 to roller 13, i.e., transfer- gear-row 16, is mounted to chassis 26. This structure allows roller 13 to be driven by motor 15 via gear-row 16 and transfer recording paper 5 in Y direction. At this time, pinch roller 14 is follower driven via recording paper 5 transferred.

In this first embodiment, the driving force transmitting machine comprises transmission-gear-row 16 formed of plural gears. The driving force of transfer motor 15 is transmitted by this transmission-gear-row 16; however, it is not limited to gear-row 16. For instance, in the driving force transmitting machine, various means such as a pulley and a belt, a gear and a shaft, or combining these tools, can transmit the driving force of motor 15 to roller 13.

Final gear 16a, an element of transmission-gear-row 16, is mounted coaxially with the rotating shaft of roller 13 on one end of roller 13. Further, rotary detector 17 is also mounted coaxially with the rotating shaft of roller 13 at outer side of final gear 16a.

On the entire rim of rotary detector 17, plural slits radially extending are formed at equal intervals. Detecting sensor 18 is disposed at a predetermined place with respect to rotary detector 17 for detecting positions of each slit to be detected (detectee). Detecting sensor 18 comprises a light-emitting-section and a light-receiving-section. The light-emitting-section irradiates detecting-light to rotary detector 17. The light-receiving-section is disposed opposite side of the light-emitting-section with respect to rotary detector 17, and receives the detecting-light irradiated from the light-emitting-section. When rotary detector 17 rotates accompanying the rotation of gear 16a, numbers of light-shadings and light-transmissions of the detecting light due to movement of the slits are recognized by the light-receiving-section. Thus a rotating angle of rotary detector 17 is detected, and the rotating volume of transfer motor 15, i.e., feeding-amount of recording paper 5 can be detected.

Detecting sensor 18 is not limited to the transmission type discussed above, and a reflecting type can be employed, which disposes both the light-emitting-section and the light-receiving-section at the same side of the rotary detector. Thus the light from the light-emitting-section reflects on the rotary detector and the reflection light can be detected by the light-receiving-section.

A pair of discharging rollers 19 (19a, 19b) for pinching and discharging recording paper 5 outside the apparatus are disposed in front of transfer roller 13 in the transfer direction (Y direction) of recording paper 5. Discharging rollers 19 synchronously rotate with roller 13.

As shown in FIG. 1, main tank 20 is disposed between pinch roller 14 and transfer motor 15. Main tank 20 comprises four tanks 20a, 20b, 20c and 20d, in which black-ink, yellow-ink, magenta-ink and cyan-ink are reserved respectively. These four tanks are aligned in X direction and rigidly mounted to the apparatus.

Respective main tanks 20a, 20b, 20c and 20d are coupled to corresponding sub-tanks 3a, 3b, 3c and 3d through flexible four tubes 21a, 21b, 21c and 21d so that the ink in main tanks can be supplied to the sub-tanks. Coupling member 22 is disposed in front of main tank 20 in Y direction. Four tubes 21 are bound together and aligned vertically by coupling member 22. Four tubes 21 extend in Y direction, then turn along X direction toward pulley 8, and bow before extending oppositely in X direction, and finally arrives at carriage 2. When carriage 2 moves in X direction, the bowed section of tube 21 moves accordingly, so that carriage 2 can travel smoothly.

Sub-tanks 3 reserve the inks enough to print several sheets of recording paper 5 in A4 size. The inks in sub-tanks 3 are ejected during the printing. Then sub-tanks 3 are supplied with the inks from main tanks 20 while the next recording paper 5 is fed in.

As such, sub-tanks 3 are provided to carriage 2, thereby speeding up ink-supply and preventing ink-shortage. Sub-tanks 3 are so small that the total mass of carriage 2 becomes light, thereby speeding up the traveling speed of carriage 2 as well as downsizing the apparatus due to narrowing the traveling space of carriage 2.

Besides one end of tube 21, one end of flexible cable 23 is connected to a side face of carriage 2. Cable 23 transmits a printing signal, for ejecting the ink from heads 1, from a printing signal generator (not shown) to driving circuit 4. The printing signal transmitted via cable 23 drives the piezoelectric element, so that the inks are ejected from the nozzles of heads 1.

At the position opposite to the home position of carriage 2 on first side in X direction, purge-unit 24 is disposed on second side in X direction. This purge-unit 24 is a sucking machine for sucking ink attached to the nozzles of heads 1, thereby cleaning the nozzles. Purge-unit 24 comprises cap 24a, ink-discharging-tube 24b and sucking pump 24c. Cap 24a moves in Z direction (perpendicular to X and Y directions) and sticks to heads 1 so that openings of all the nozzles of heads 1 can be covered. The shielded space-formed by sticking cap 24a to heads 1-communicates with wasted-ink-container 25, disposed adjacent to main tanks 20, through tube 24b. Sucking pump 24c is disposed at the middle of tube 24b, and sucks ink attached to the nozzles, then discharges it into container 25.

Wiper 24d made of rubber is disposed near cap 24a, and movable in Z direction independent of cap 24a and wipes nozzles' faces. Wiper 24d sticks to nozzles' faces and retreats therefrom. When wiper 24d is urged against the nozzles' faces, carriage 2 is moved in the scanning direction (X direction), so that wiper 24d relatively moves with respect to the nozzles' faces and the ink attached to the nozzles' faces can be wiped off.

Next, rotary detector 17 is detailed. As shown in FIG. 2, rotary detector 17 is disposed within height “H” of transmission gear-row 16. The height of transmission gear-row 16 indicates one of the following three heights, i.e., H1, H2 and H3:

“H1”: As shown in FIG. 3, when the inkjet recording apparatus is placed on a horizontal plane, the distance between the horizontal line running at the lowest end of gear-row 16 and the horizontal line running at the highest end of gear-row 16 is referred to as height “H1”.

“H2”, “H3”: As shown in FIG. 4 and FIG. 5, only gear-row 16 is selected and placed on a flat face. A tangent line common to any two gears coming in contact with the flat face is considered the lowest end, and a line parallel to this tangent line and running at the highest end is considered. The space between these two lines is referred to “H2” or “H3”.

As such, rotary detector 17 is placed within the height of gear-row 16, then at the assembly of the apparatus, even if other members hit any elements of gear-row 16 having rigidity, they never hit thin rotary detector 17. Thus rotary detector 17 can be prevented from being damaged or deformed by a shock. As a result, disablement of detecting the rotating angle due to damages of rotary detector 17 can be avoided, and an incorrect detection of the rotating angle because the rotating face shakes due to deformation of rotary detector 17 can be also avoided.

In addition to placing rotary detector 17 within the height of gear-row 16, rotary detector 17 is mounted to outside of gear-row 16 as shown in the drawings. Therefore, the ink ejected from the nozzles would splash to gear-row 16 but not so far to rotary detector 17, detecting sensor 18, the light-emitting-section and the light-receiving-section. Thus a detection error of the rotating angle due to the ink attached to rotary detector 17 or detecting sensor 18 can be prevented.

In general, splashing of the ink tends to happen particularly in high speed printing, or printing letters with a small dot diameter. For instance, the ink-splash reveals itself as a problem in the following condition aiming at high speed and high quality image recording:

resolution ≧600 dpi, printing speed ≧80 cm/sec at 20 kHz, ink ejecting amount ≦20 pl. Further, when the ink ejecting amount lowers less than 4 pl, the problem becomes more serious. Therefore, the fact that the present invention solves the problem of attaching ink to rotary detector 17 is a great advantage for realizing high speed printing and high quality image recording.

### Second Exemplary Embodiment

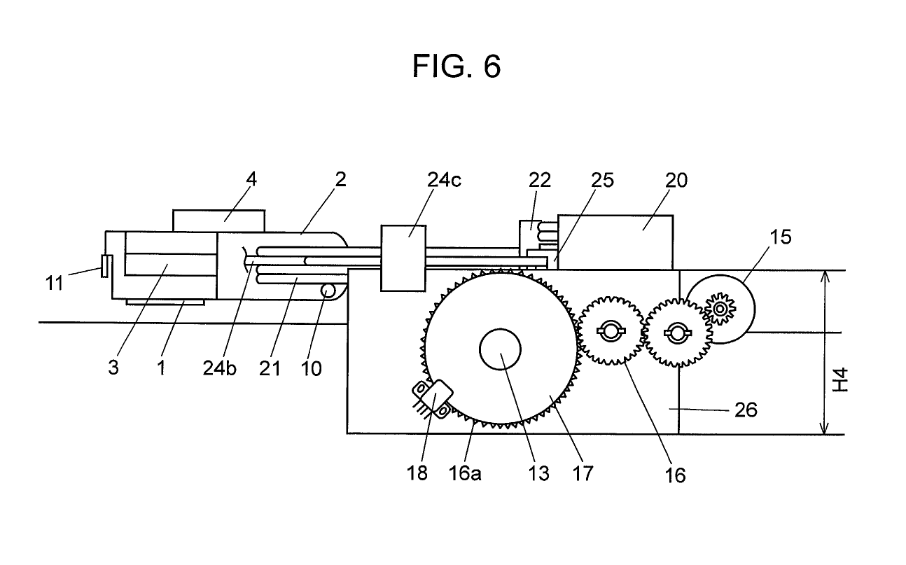

FIG. 6 is a lateral view of an essential part of an inkjet recording apparatus in accordance with the second exemplary embodiment of the present invention.

In the first embodiment discussed previously, the rotary detector is placed within the height of the transmission gear-row. However, in this second embodiment as shown in FIG. 6, rotary detector 17 is placed within height H4 of chassis 26 to which transmission gear-row 16 is mounted. In this structure, other members happen to hit transmission gear-row 16 or chassis 26 by mistake; however they hardly hit rotary detector 17. Thus this structure prevents rotary detector 17 from being damaged or deformed by a shock.

Since rotary detector 17 is mounted outside of chassis 26, a detection error of a rotating angle due to attaching ink to detector 17 can be prevented.

In the first and second embodiments, rotary detector 17, together with final gear 16a, is mounted to transfer roller 13, so that a detection error of a rotating angle due to back-rush is eliminated. The rotary detector can be, as long as it is placed within the height of the gear-row or the height of the chassis, mounted coaxially with a rotating shaft of other rotating members such as another gear instead of the final gear.

In the first and second embodiments, main tanks 20 are separately disposed from carriage 2; however, the ink tanks can be disposed on the carriage side. Further, a cartridge, in which the heads and ink tanks are integrated, can be employed.

In the first and second embodiments, an optical sensor is described as detecting sensor 18; however, a magnetic type sensor, comprising magnetic slits and a magnetic detecting sensor, can be used with the same advantages.

### Third Exemplary Embodiment

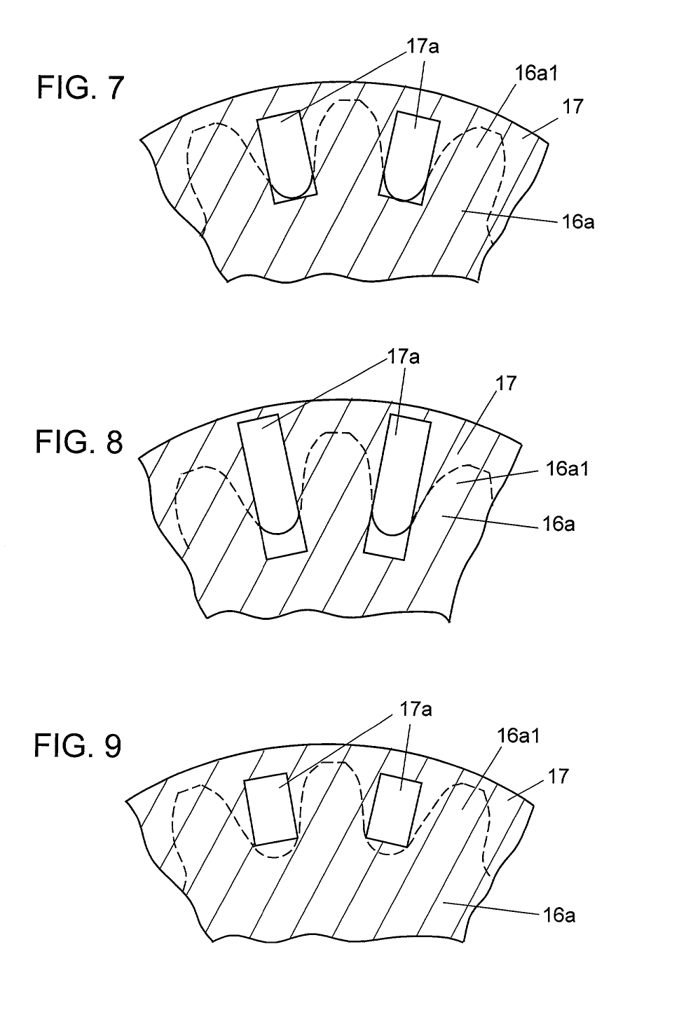

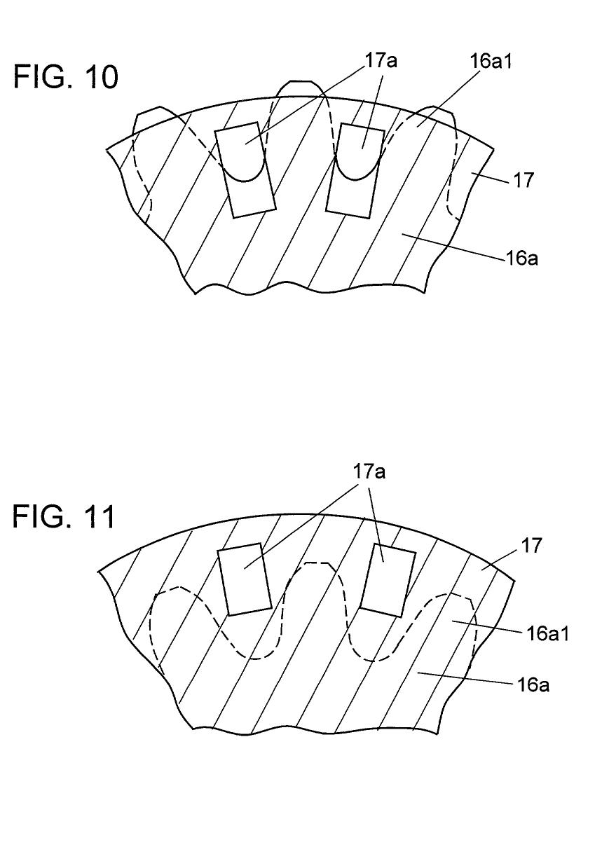

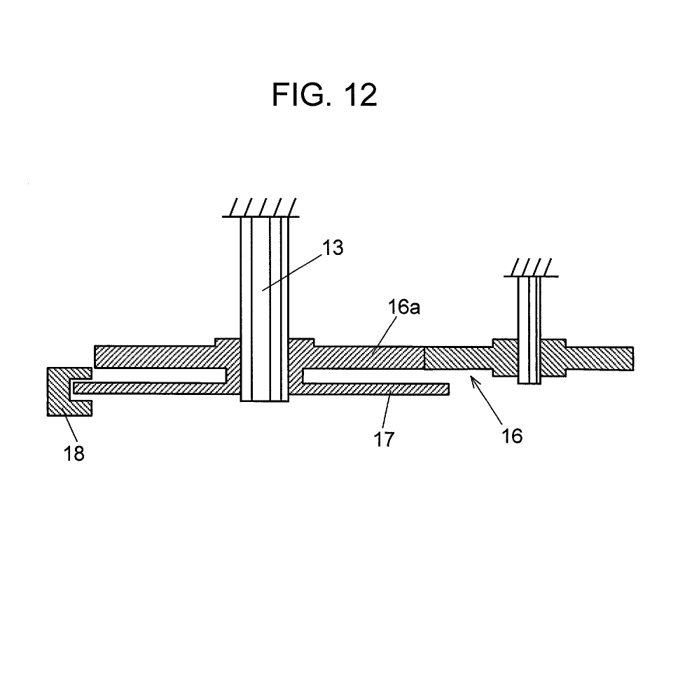

FIG. 7 illustrates an example of a relation between the final gear of a transmission-gear-row and slits formed on a rotary detector in an inkjet recording apparatus in accordance with the third exemplary embodiment. FIG. 8 illustrates another example of the relation between the final gear and the slits. FIG. 9 illustrates still another example of the relation between the final gear and the slits. FIG. 10 illustrates yet still another example of the relation between the final gear and the slits. FIG. 11 illustrates further another example of the relation between the final gear and the slits. FIG. 12 is a cross sectional view showing the final gear and the rotary detector. In these drawings, the elements same as those used in the first and second embodiments bear the same reference marks and the descriptions thereof are omitted.

As shown in FIG. 7 through FIG. 11, the third embodiment shows positional relations between slit 17a formed on rotary detector 17 and tooth form 16a1 of final gear 16a. In these relations, at least a part of slit 17a is placed within the height of tooth form 16a1, which is demonstrated in the following examples:

(1) As shown in FIG. 7, the length of slit 17a is equal to the height of tooth form 16a1.

(2) As shown in FIG. 8, both the ends of slit 17a in its longitudinal direction are located outside of both the ends of tooth form 16a1 in the height direction.

(3) As shown in FIG. 9, the length of slit 17a is within the height of tooth form 16a1.

(4) As shown in FIG. 10, the outer end of slit 17a in the longitudinal direction is located within the height of tooth form 16a1, and the inner end of slit 17a in the longitudinal direction is located inside of the inner end of tooth form 16a1 in the height direction.

(5) As shown in FIG. 11, the inner end of slit 17a in the longitudinal direction is located within the height of tooth form 16a1, and the outer end of slit 17a is outside the outer end in the height direction of tooth form 16a1.

These relations can be applied to a case where a pulley with teeth, or a simple pulley is used instead of gear 16a, e.g., in the case of using the pulley, the outside discussed above refers to the outer end of a lib, the inside discussed above refers to a bottom of a tooth in the case of the pulley with teeth, and the inside refers to inner bottom in the case of a simple pulley.

As such, according to the third embodiment, at least a part of slit 17a, formed on rotary detector 17 which is mounted to the rotating shaft of final gear 16a, is located within the height of tooth form 16a1 of gear 16a. Thus while rotary detector 17 can be detected at high accuracy, it can be downsized.

Rotary detector 17 is disposed outside gear 16a with respect to head 1, so that ink-mist splashed does not attach to rotary detector 17, and a detection error of a rotating angle can be avoided. This advantage becomes effective in the condition of: resolution ≧600 dpi; printing speed ≧20 kHz, 80 cm/sec; ink ejecting amount ≦20 pl. When the ink ejecting amount lowers less than 4 pl, this advantage produces conspicuous effect.

The rotating shaft is spun, so that rotary detector 17 is compared with gear 16a in their rotating conditions. Thus the eccentricity of rotary detector 17 can be checked with ease.

As shown in FIG. 12, rotary detector 17 can be unitarily molded with final gear 16a which shares the same rotating shaft with detector 17. In this case, co-axiality of rotary detector 17 with gear 16a is improved, which allows the detection of rotating angle to be more accurate.

As same as the first and second embodiments, in this third embodiment, rotary detector 17 is mounted together with final gear 16a to transfer roller 13, so that a detection error of a rotating angle due to back-rush can be eliminated. However, rotary detector 17 can be mounted coaxially with a rotating shaft of another gear of the transmission gear-row. Rotary detector 17 is disposed outside gear 16a; however, it can be disposed inside thereof.

### Fourth Exemplary Embodiment

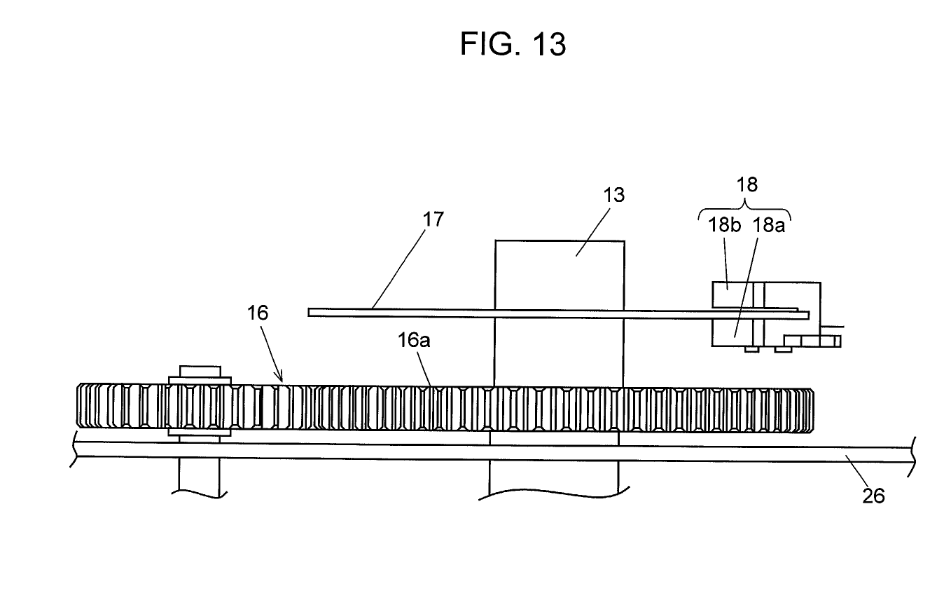

FIG. 13 is a plan view showing an essential part of an inkjet recording apparatus in accordance with the fourth exemplary embodiment. In FIG. 13, the elements as same as those used in the first, second and third embodiments bear the same reference marks, and the descriptions thereof are omitted.

In this fourth embodiment as shown in FIG. 13, light-emitting-section 18a of detecting sensor 18 is disposed between final gear 16a of the transmission gear-row and rotary detector 17. In this placement, rotary detector 17 has approx. the same diameter as gear 16a on the same shaft as detector 17, therefore, protrusion amount of sensor 18 in the radial direction of gear 16a can be restrained. In particular, if rotary detector 17 has a smaller diameter than gear 16a, the protrusion amount of sensor 18 can be further restrained.

Rotary detector 17 is placed outside gear 16a with respect to head 1, so that splashed ink-mist cannot attach to rotary detector 17. Thus a detection error of a rotating angle can be avoided. This advantage becomes effective conspicuously at high speed printing with small amount of ink ejection as same as the first, second and third embodiments.

In this fourth embodiment, light-emitting-section 18a of detecting sensor 18 is disposed between gear 16a and rotary detector 17; however, light-receiving-section 18b can be disposed instead of light-emitting-section 18a. As such, either one of light-emitting-section 18a or light-receiving-section 18b is disposed between final gear 16a and rotary detector 17, so that ink-mist-produced at high speed printing with small amount of ink ejection-hardly attaches to detecting sensor 18.

In this fourth embodiment, detecting sensor 18 is disposed within height “H” of transmission gear-row 16 as shown in FIG. 2, so that sensor 18 is prevented from protruding in the height direction of the apparatus. As a result, the apparatus can be slimed down.

What is claimed is:

1. An inkjet recording apparatus comprising:
(a) a carriage for shuttling back and forth in parallel with a main scanning direction;
(b) a recording head for ejecting ink from a plurality of nozzles, and mounted to said carriage;
(c) a transferring machine for transferring a recording medium, on which an image is formed by attaching ink ejected from said head, in a sub-scanning direction orthogonal to the main scanning direction;
(d) a driving machine for operating said transferring machine;
(e) a driving-force-transmitting-machine for transmitting driving force of said driving machine to said transferring machine, and disposed between said driving machine and said transferring machine;
(f) a rotary detector mounted coaxially with a rotating shaft of a rotating member, an element of said driving-force-transmitting-machine, and disposed within a height of said driving-force-transmitting-machine; and
(g) a detecting sensor for detecting a rotating angle of said rotary detector.

2. The inkjet recording apparatus of claim 1, wherein said rotary detector is mounted outside said driving-force-transmitting-machine.

3. The inkjet recording apparatus of claim 1, wherein said rotary detector is mounted coaxially with a final gear of said driving-force-transmitting-machine.

4. An inkjet recording apparatus comprising:
(a) a carriage for shuttling back and forth in parallel with a main scanning direction;
(b) a recording head for ejecting ink from a plurality of nozzles, and mounted to said carriage;
(c) a transferring machine for transferring a recording medium, on which an image is formed by attaching ink ejected from said head, in a sub-scanning direction orthogonal to the main scanning direction;
(d) a driving machine for operating said transferring machine;
(e) a driving-force-transmitting-machine for transmitting driving force of said driving machine to said transferring machine, and disposed between said driving machine and said transferring machine;
(f) a chassis to which said driving-force-transmitting-machine is mounted;
(g) a rotary detector mounted coaxially with a rotating shaft of a rotating member, an element of said driving-force-transmitting-machine, and disposed within a height of said chassis; and
(h) a detecting sensor for detecting a rotating angle of said rotary detector.

5. The inkjet recording apparatus of claim 4, wherein said rotary detector is mounted outside said chassis.

6. The inkjet recording apparatus of claim 4, wherein said rotary detector is mounted coaxially with a final gear of said driving-force-transmitting-machine.

7. An inkjet recording apparatus comprising:
(a) a carriage for shuttling back and forth in parallel with a main scanning direction;
(b) a recording head for ejecting ink from a plurality of nozzles, and mounted to said carriage;
(c) a transferring machine for transferring a recording medium, on which an image is formed by attaching ink ejected from said head, in a sub-scanning direction orthogonal to the main scanning direction;
(d) a driving machine for operating said transferring machine;
(e) a driving-force-transmitting-machine for transmitting driving force of said driving machine to said transferring machine, and disposed between said driving machine and said transferring machine;
(f) a rotary detector mounted coaxially with a rotating shaft of a gear, an element of said driving-force-transmitting-machine, and a plurality of slits extending in a radial direction being formed on an entire rim of said rotary detector at equal intervals, and at least a part of the slits being disposed within a height of a tooth form of the gear; and
(g) a detecting sensor for detecting a rotating angle of said rotary detector based on a number of slits moved due to rotating of said rotary detector.

8. The inkjet recording apparatus of claim 7, wherein said rotary detector is unitarily molded with the gear mounted coaxially with a rotating shaft of said rotary detector.

9. The inkjet recording apparatus of claim 7, wherein said rotary detector is mounted coaxially with a final gear of said driving-force-transmitting-machine.

10. The inkjet recording apparatus of claim 7, wherein said rotary detector is disposed outside the gear with respect to said recording head.

11. An inkjet recording apparatus comprising:
(a) a carriage for shuttling back and forth in parallel with a main scanning direction;
(b) a recording head for ejecting ink from a plurality of nozzles, and mounted to said carriage;
(c) a transferring machine for transferring a recording medium, on which an image is formed by attaching ink ejected from said head, in a sub-scanning direction orthogonal to the main scanning direction;
(d) a driving machine for operating said transferring machine;
(e) a driving-force-transmitting-machine for transmitting driving force of said driving machine to said transferring machine, and disposed between said driving machine and said transferring machine;
(f) a rotary detector mounted coaxially with a rotating shaft of a rotating member, an element of said driving-force-transmitting-machine, and a plurality of slits extending in a radial direction being formed on an entire rim of said rotary detector at equal intervals; and
(g) a detecting sensor including:
(g-1) a light-emitting-section for irradiating detecting light to the slit of said rotary detector;
(g-2) a light-receiving-section for receiving the detecting light irradiated from the light-emitting-section, and being disposed opposite to the light-emitting-section with respect to said rotary detector,
wherein said detecting sensor detects a rotating angle of said rotary detector by recognizing light-shading and light-transmission of the detecting light at the light-receiving-section when the slits move due to rotating of said rotary detector, and either one of the light-emitting-section or the light-receiving-section is disposed between the rotating member and said rotary detector.

12. The inkjet recording apparatus of claim 11, wherein a diameter of said rotary detector is not more than a diameter of the rotating member located coaxially with said rotary detector.

13. The inkjet recording apparatus of claim 11, wherein the rotating member is a final gear mounted coaxially with said transferring machine.

14. The inkjet recording apparatus of claim 11, wherein said rotary detector is disposed outside the rotating member with respect to said recording head.

15. An inkjet recording apparatus comprising:
(a) a carriage for shuttling back and forth in parallel with a main scanning direction;
(b) a recording head for ejecting ink from a plurality of nozzles, and mounted to said carriage;
(c) a transferring machine for transferring a recording medium, on which an image is formed by attaching ink ejected from said head, in a sub-scanning direction orthogonal to the main scanning direction;
(d) a driving machine for operating said transferring machine;
(e) a driving-force-transmitting-machine for transmitting driving force of said driving machine to said transferring machine, and disposed between said driving machine and said transferring machine;
(f) a rotary detector mounted coaxially with a rotating shaft of a rotating member, an element of said driving-force-transmitting-machine, and a detectee extending in a radial direction being formed on an entire rim of said rotary detector; and
(g) a detecting sensor for detecting a rotating angle responsive to rotating of said rotary detector, and being disposed between the rotating member and said rotary detector.

16. The inkjet recording apparatus of claim 1, wherein said transferring machine is a transfer roller.

17. The inkjet recording apparatus of claim 4, wherein said transferring machine is a transfer roller.

18. The inkjet recording apparatus of claim 7, wherein said transferring machine is a transfer roller.

19. The inkjet recording apparatus of claim 11, wherein said transferring machine is a transfer roller.

20. The inkjet recording apparatus of claim 15, wherein said transferring machine is a transfer roller.

21. The inkjet recording apparatus of claim 1, wherein said driving machine is a dc motor.

22. The inkjet recording apparatus of claim 4, wherein said driving machine is a dc motor.

23. The inkjet recording apparatus of claim 7, wherein said driving machine is a dc motor.

24. The inkjet recording apparatus of claim 11, wherein said driving machine is a dc motor.

25. The inkjet recording apparatus of claim 15, wherein said driving machine is a dc motor.
